(19) United States
(12) Patent Application Publication
(10) Pub. No.: US 2026/0364469 A1
(43) Pub. Date: Nov. 19, 2026

(54) VIRTUAL GAIN ITEM SENDING METHOD AND DEVICE, MOBILE TERMINAL, AND STORAGE MEDIUM

(71) Applicant: NETEASE (HANGZHOU) NETWORK CO., LTD., Hangzhou (CN)

(72) Inventor: Wenzhen WEN, Hangzhou (CN)

(21) Appl. No.: 19/136,837

(22) PCT Filed: May 23, 2023
(86) PCT No.: PCT/CN2023/095854

§ 371 Date: Jun. 6, 2025

(30) Foreign Application Priority Data
Dec. 6, 2022 (CN) 202211559223.2

(51) Int. Cl. A63F 13/69; A63F 13/75; A63F 13/79

(52) U.S. Cl. CPC A63F 13/69; A63F 13/75; A63F 13/79

(57) ABSTRACT

The present solution comprises: receiving live streaming room interaction notification information; on the basis of a first mapping relationship between a live streaming room identifier and a game account, determining a target game account corresponding to live streaming room identifier information; on the basis of a second mapping relationship between an interaction content identifier and a virtual gain item, determining a target virtual gain item corresponding to interaction content identifier information; generating a target frame synchronization instruction; and sending the target frame synchronization instruction to a user terminal to which the target game account is logged in.

### CROSS-REFERENCE TO RELATED APPLICATION

The present disclosure is a 371 national phase application of PCT Application No. PCT/CN2023/095854 filed May 23, 2023, which claims priority to Chinese Patent Application No. 202211559223.2 filed with the China National Intellectual Property Administration on 6 Dec. 2022 and titled “METHOD FOR TRANSMITTING VIRTUAL GAIN ITEM, APPARATUS FOR TRANSMITTING VIRTUAL GAIN ITEM, MOBILE TERMINAL, AND STORAGE MEDIUM”, the entire content of which applications are incorporated herein by reference.

### TECHNICAL FIELD

The present disclosure relates to the field of electronic games, and specifically relates to a method, system, and apparatus for transmitting a virtual gain item in online games.

### BACKGROUND

In an online game, a game anti-cheating solution is often adopted to maintain game balance.

Existing anti-cheating solutions typically include: I. Encrypting sensitive information to prevent decryption, such as encrypting a local memory of a user terminal, encrypting a communication protocol between the user terminal and a server, and hiding an interface of function code; and II. Post-event inspection, such as backstage cheating software detection or data exception detection.

However, the above anti-cheating solutions have shown limited effectiveness in preventing cheating behaviors.

### SUMMARY

The present disclosure provides a method, system, and apparatus for transmitting a virtual gain item, an apparatus for transmitting a virtual gain item in online games to prevent cheating behaviors.

According to a first aspect, the present disclosure provides a method for transmitting a virtual gain item, including: receiving an interaction notification message in a live broadcasting room, where the interaction notification message in the live broadcasting room includes a live broadcasting room identifier and an interactive content identifier; determining a target game account corresponding to the live broadcasting room identifier based on a first mapping relationship; determining a target virtual gain item corresponding to the interactive content identifier based on a second mapping relationship, where the target virtual gain item generates a gain effect on a game character in a game; generating a target frame synchronization instruction, where the target frame synchronization instruction includes creation information of the target virtual gain item; and transmitting the target frame synchronization instruction to a user terminal logged in with the target game account, to synchronize game progress between the target game account and other game accounts involved in a same game round, and to enable the target game account to acquire the target virtual gain item in the game.

According to a second aspect, the present disclosure provides a system including one or more memory collectively containing one or more programs, and one or more processors, where the one or more processors are configured to, individually or collectively, perform the operations of one or more steps of the above-described method for transmitting a virtual gain item.

According to a third aspect, the present disclosure provides one or more non-transitory computer-readable storage media containing, in any combination, computer program code that, when executed by a computer system, perform operations of one or more steps of the above-described method for transmitting a virtual gain item.

### BRIEF DESCRIPTION OF THE DRAWINGS

To more clearly describe technical solutions of embodiments of the present disclosure, drawings to be used in the description of the embodiments will be briefly introduced below. Apparently, the drawings described below are merely some embodiments of the present disclosure. For those skilled in the art, other drawings may also be obtained based on these drawings without creative work.

FIG. 1a is a schematic flowchart of a method for transmitting a virtual gain item provided in one of embodiments of the present disclosure.

FIG. 1b is a specific example structural block diagram of generating and transmitting a target frame synchronization instruction by a server provided in one of embodiments of the present disclosure.

FIG. 1c is a specific example structural block diagram of pre-checking a control instruction by a server provided in one of embodiments of the present disclosure.

FIG. 1d is an example structural block diagram of a specific embodiment of generating a target frame synchronization instruction by a server provided in one of embodiments of the present disclosure.

FIG. 1e is a schematic diagram of a specific embodiment of a game running interface provided in one of embodiments of the present disclosure.

FIG. 2 is a schematic diagram of a specific embodiment of a method for transmitting a virtual gain item provided in one of embodiments of the present disclosure.

FIG. 3 is a schematic structural diagram of an apparatus for transmitting a virtual gain item provided in one of embodiments of the present disclosure.

FIG. 4 is a schematic structural diagram of a computer device provided in one of embodiments of the present disclosure.

### DETAILED DESCRIPTION

The technical solutions of the embodiments of the present disclosure will be clearly and completely described below in conjunction with the drawings in the embodiments of the present disclosure. Apparently, the embodiments described below are merely a part, instead of all, of the embodiments of the present disclosure. All other embodiments obtained by those skilled in the art based on the embodiments of the present disclosure without creative work are encompassed within the scope of protection of the present disclosure.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, to perform a particular function.

The embodiments of the present disclosure provide a method, system, and apparatus for transmitting a virtual gain item.

The method for transmitting a virtual gain item specifically may be integrated in an electronic device, which may be a device, such as a terminal or a server. The terminal may be a device, such as a mobile phone, a tablet computer, a smart Bluetooth device, a notebook computer, or a Personal Computer (PC); and the server may be a single server, or may be a server cluster composed of a plurality of servers.

In some embodiments, the method for transmitting a virtual gain item may also be integrated in a plurality of electronic devices. For example, the method for transmitting a virtual gain item may be integrated in the plurality of servers, and the method for transmitting a virtual gain item in the present disclosure may be implemented by the plurality of servers.

In some embodiments, the server may also be implemented in the form of the terminal.

For example, in some embodiments, the electronic device may be the server, which can receive an interaction notification message in a live broadcasting room in the embodiments, where the interaction notification message in the live broadcasting room comprises live broadcasting room identifier information and interactive content identifier information; determine a target game account corresponding to the live broadcasting room identifier information based on a first mapping relationship between a live broadcasting room identifier and a game account; determine a target virtual gain item corresponding to the interactive content identifier information based on a second mapping relationship between an interactive content identifier and a virtual gain item, where the virtual gain item is a virtual item for generating a gain effect on a game character in a game; generate a target frame synchronization instruction, where the target frame synchronization instruction carries creation information of the target virtual gain item; and transmit the target frame synchronization instruction to a user terminal logged in with the target game account, to synchronize game progress between the target game account and other game accounts involved in a same game round, and enable the target game account to acquire the target virtual gain item in the game.

A method for transmitting a virtual gain item in one embodiment of the present disclosure may run on a terminal device or the server. The terminal device may be a local terminal device. When the method for transmitting a virtual gain item runs on the server, the method may be implemented and executed based on a cloud interaction system, where the cloud interaction system comprises a server and a client device.

In some embodiments, various cloud applications, such as a cloud game, may run under the cloud interaction system. Taking the cloud game as an example, the cloud game refers to a game method based on cloud computing. In an operating mode of the cloud game, an entity for operating a game program and an entity for presenting a game picture are separated. The storage and operation of the method for transmitting a virtual gain item are completed on a cloud game server. The client device functions to receive data, transmit data, and present the game picture. For example, the client device may be a display device with data transmission function in the vicinity of the user side, such as a terminal, a television set, a computer, or a palm computer. However, the terminal device transmitting the virtual gain item is a cloud game server in cloud. When playing a game, a user operates the client device to transmit an operating instruction to the cloud game server, such as an operating instruction of a touch operation. The cloud game server runs the game based on the operating instruction, encodes and compresses data such as the game picture, returns the data to the client device through a network, and finally decodes the data and outputs the game picture through the client device.

In some embodiments, the terminal device may be a local terminal device. Taking the game as an example, the local terminal device stores the game program and is configured to present the game picture. The local terminal device is configured to interact with the user through a graphical user interface, namely, the game program is downloaded, installed, and operated through an electronic device conventionally. The local terminal device may provide the graphical user interface to the user in various modes, for example, it may be rendered and displayed on a display screen of the terminal, or provided to the user through holographic projection. For example, the local terminal device may comprise a display screen and a processor. The display screen is configured to present the graphical user interface. The graphical user interface comprises the game picture. The processor is configured to run the game, generate the graphical user interface, and control display of the graphical user interface on the display screen.

A game scenario (or referred to as a virtual scenario) is a virtual scenario displayed (or provided) when an application program is running on the terminal or the server. In some embodiments, the virtual scenario is a simulation environment of real world, or is a partially simulated and partially fictional virtual environment, or is a purely fictional virtual environment. The virtual scenario is any one of a two-dimensional virtual scenario and a three-dimensional virtual scenario. The virtual environment may be, e.g., the sky, land, or ocean, where the land includes an environmental element, such as a desert or a city. The virtual scenario is a scenario of complete game logic of a virtual object such as user control. For example, in a sandbox 3D shooting game, the virtual scenario is a 3D game world for a user to control the virtual object to battle. Example virtual scenarios may include: at least one element of mountains, plains, rivers, lakes, oceans, deserts, sky, plants, buildings, and vehicles.

A game interface refers to an interface corresponding to an application program provided or displayed through a graphical user interface, and includes the graphical user interface for interaction between users and the game picture, which is a picture of a game scenario.

In some embodiments, the UI interface may include a game widget (such as a skill widget, a behavior widget, or a functional widget), an indicator identifier (such as a direction indicator identifier and a character indicator identifier), an information display region (such as a kill count and a game duration), or a game setting widget (such as system settings, stores, or gold coins).

In some embodiments, the game picture is a display picture corresponding to a virtual scenario displayed on a terminal device, and the game picture may include a virtual object, such as a game object, a Non-Player Character (NPC), and an Artificial Intelligence (AI) character, that executes game logic in the virtual scenario.

For example, in some embodiments, content displayed in the graphical user interface at least partially comprises a game scenario, where the game scenario comprises at least one game object.

In some embodiments, the game object in the game scenario includes a virtual object, which is a user object manipulated by a player.

The game object refers to the virtual object in the virtual scenario, including a game character, which is a controllable dynamic object (also referred to as a dynamic virtual object). In some embodiments, the dynamic object may be, e.g., a virtual character, a virtual animal, or an animated character. The virtual object is a character controlled by the user through an input device, or is AI provided in a battle of a virtual environment by training, or is a NPC provided in a battle of a virtual scenario.

In some embodiments, the virtual object is a virtual character competing in the virtual scenario. In some embodiments, the number of virtual objects in the battle of the virtual scenario is preset, or is dynamically determined based on the number of clients joining the battle, which is not limited in the embodiments of the present disclosure.

In a possible implementation, the user can control the virtual object to perform a game behavior in the virtual scenario, where the game behavior may include, e.g., moving, releasing a skill, using a prop, or dialoging, for example, control the virtual object to, e.g., run, jump, or crawl, and can also control the virtual object to battle with other virtual objects using a skill, a virtual prop, etc. provided by the application program.

As an indispensable component for the game scenario picture, a virtual camera is configured to present the game scenario picture. One game scenario at least corresponds to one virtual camera, or two or more than two virtual cameras may be provided based on actual requirements, and serve as a window for game rendering to capture and present picture content of game world for the user. Parameters of the virtual camera are set to adjust a perspective of the user watching the game world, such as a first-person perspective and a third-person perspective.

The detailed description is provided below respectively. It should be noted that the serial numbers of the embodiments below do not impose any limitation on a preferred order of the embodiments.

One embodiment of the present disclosure is intended to provide a method for transmitting a virtual gain item. Creation information is carried in a target frame synchronization instruction transmitted from a server to a user terminal, to enable a target game account to acquire a target virtual gain item in a game. The creation information is transmitted from the server and cannot be separately generated locally on the user terminal, thereby avoiding, in an embodiment of the present disclosure, a cheating behavior caused by modifying local parameters of the user terminal in an existing solution, and improving the effects on preventing the cheating behavior.

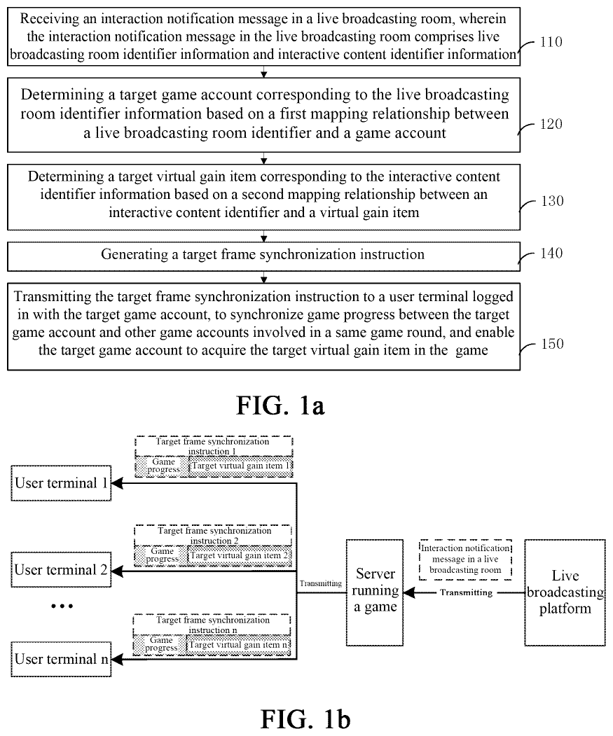

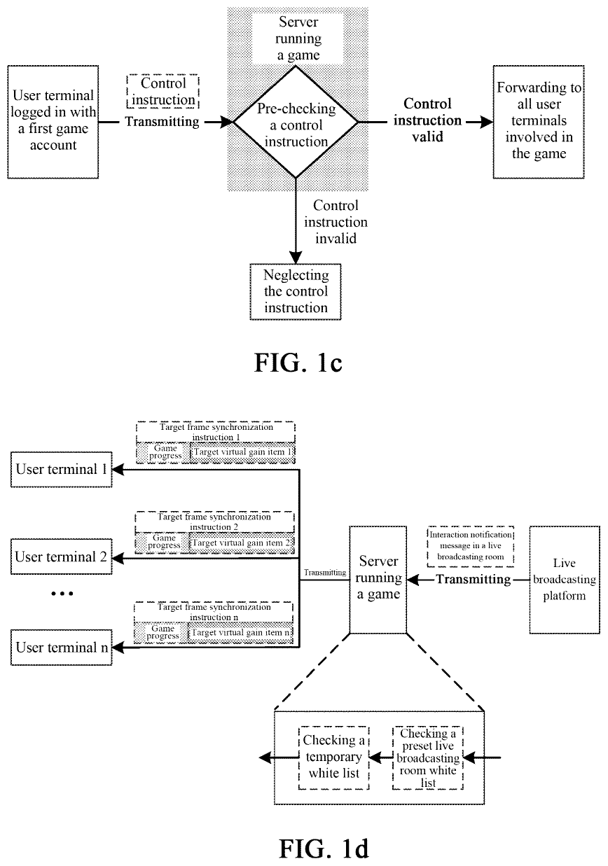

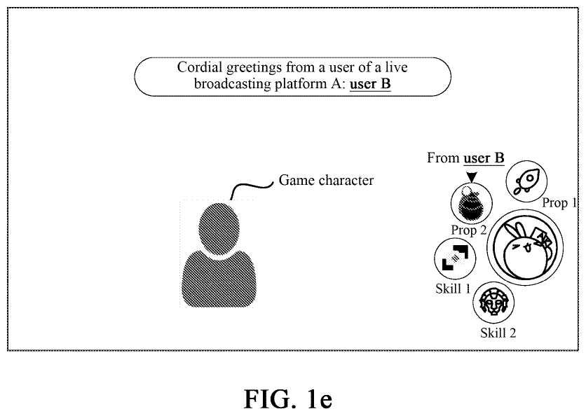

Referring to FIG. 1a, FIG. 1a is a schematic flowchart of a method for transmitting a virtual gain item provided in an embodiment of the present disclosure. The method for transmitting a virtual gain item may be executed by a server running a game, and the specific process may include the following steps 110 to 150.
110: receiving an interaction notification message in a live broadcasting room, where the interaction notification message in the live broadcasting room comprises live broadcasting room identifier information and interactive content identifier information.

The interaction notification message in the live broadcasting room is a notification message triggered by an interactive behavior between an audience and a streamer in the live broadcasting room. The interaction notification message in the live broadcasting room may be generated using a live broadcasting server corresponding to the live broadcasting room, and transmitted by the live broadcasting server to the server running the game.

The live broadcasting room identifier information is identifier information that characterizes the uniqueness of the live broadcasting room. For example, the live broadcasting room identifier information may be an Identity document (ID) of the live broadcasting room, or may be a live broadcasting account ID of a streamer on a live broadcasting platform. The specific form of the live broadcasting room identifier information should not be construed as limiting the present disclosure.

Interactive content is specific behavioral content of the interactive behavior between the audience and the streamer, and may include, e.g., a bullet comment sent by the audience in the live broadcasting room or a gift sent by the audience to the streamer in the live broadcasting room. The interactive content identifier information is used to distinguish between different interactive contents. The bullet comment sent by the audience in the live broadcasting room and different gifts sent by the audience to the streamer in the live broadcasting room may be distinguished by different interactive content identifier information. For example, the bullet comment sent by the audience in the live broadcasting room may be recorded as: interactive content identifier information a; gift 1 sent by the audience in the live broadcasting room may be recorded as: interactive content identifier information b1; and gift 2 sent by the audience in the live broadcasting room may be recorded as: interactive content identifier information b2.
120: determining a target game account corresponding to the live broadcasting room identifier information based on a first mapping relationship between a live broadcasting room identifier and a game account.

The first mapping relationship is used to reflect a mapping relationship between the live broadcasting room identifier and the game account. The first mapping relationship may be pre-stored in the server running the game. In an embodiment of the present disclosure, an association relationship between a live broadcasting room of the live broadcasting platform and a game character corresponding to a game account in the game may be established based on the first mapping relationship. The game account corresponding to the live broadcasting room identifier information may be searched based on the first mapping relationship, and the game account may be denoted as the target game account.
130: determining a target virtual gain item corresponding to the interactive content identifier information based on a second mapping relationship between an interactive content identifier and the virtual gain item.

The virtual gain item is a virtual item for generating a gain effect on the game character in the game. For example, the virtual gain item may be a game prop for use by the game character in the game, and the game prop may be an attacking prop, such as a virtual weapon; or may be a restoring prop, such as a virtual herb. The virtual gain item may also be a game skill for release by the game character in the game, and the game skill may be an attacking skill, such as releasing light wave or swordkee; or may be a healing skill, such as releasing a regional range of a circular shape in a game scenario. Whenever a friendly game character enters the regional range, a hit point value can be restored, etc.

The second mapping relationship is used to reflect a mapping relationship between the interactive content identifier and the virtual gain item. The second mapping relationship may also be pre-stored in the server running the game. In an embodiment of the present disclosure, an association relationship between the interactive content identifier and the virtual gain item may be established based on the second mapping relationship. The virtual gain item corresponding to the interactive content identifier information may be searched based on the second mapping relationship, and the virtual gain item may be denoted as the target virtual gain item.
140: generating a target frame synchronization instruction.

The target frame synchronization instruction carries creation information of the target virtual gain item. The creation information may include: the live broadcasting room identifier information, the interactive content identifier information, the number corresponding to each interactive content identifier information respectively, audience user information initiating the interactive content, the target game account, etc.

The frame synchronization instruction is an instruction issued by the server running the game for implementing data synchronization among a plurality of game clients.
150: transmitting the target frame synchronization instruction to a user terminal logged in with the target game account, to synchronize game progress between the target game account and other game accounts involved in a same game round, and enable the target game account to acquire the target virtual gain item in the game.

After receiving the target frame synchronization instruction, a client on the user terminal logged in with the target game account will perform two actions as follows: synchronizing the game progress between a game character corresponding to the target game account and game characters corresponding to the other game accounts involved in the same game round; and enabling the game character corresponding to the target game account to acquire the target virtual gain item in the game. The target virtual gain item is generated by initiating the interactive content by an audience user in the live broadcasting room, where the live broadcasting room is a live broadcasting room pointed to by the live broadcasting room identifier information, and the live broadcasting room identifier information corresponds to the target game account.

In the above embodiments, a live broadcasting room of the live broadcasting platform may be associated with a game account in the game. When an audience performs an interactive behavior such as sending a bullet comment or sending a gift in the above live broadcasting room, the live broadcasting platform can transmit the interaction notification message in the live broadcasting room to the server running the game. The interaction notification message in the live broadcasting room comprises a corresponding game account and the creation information of the target virtual gain item. The server can create a corresponding target frame synchronization instruction based on the above information. Game progress information for synchronizing the game progress in the target frame synchronization instruction is same. Different game accounts have their own corresponding creation information of the target virtual gain item, which is usually different from each other, as detailed in FIG. 1b. Target frame synchronization instruction 1 transmitted to user terminal 1 carries creation information associated with target virtual gain item 1, target frame synchronization instruction 2 transmitted to user terminal 2 carries creation information associated with target virtual gain item 2, . . . , and target frame synchronization instruction n transmitted to user terminal n carries creation information associated with target virtual gain item n. Game characters of game accounts logged in on the above user terminals in the game can acquire the corresponding target virtual gain items, as detailed in FIG. 1e. “Cordial greetings” sent by user B of live broadcasting platform A in the live broadcasting room are converted to prop 2 possessed by a corresponding game character. Therefore, the streamer in the live broadcasting room can increase the audience's sense of participation by live streaming of the above game, to realize more diverse interactions between the streamer and the audience.

In some embodiments, the target virtual gain item may be set to: only being allowed to be acquired by a game character corresponding to an associated game account, thereby enhancing the audience's sense of participation in providing game assistance to his favorite streamer. It should be understood that the target virtual gain item may also be set to: being allowed to be acquired by all game characters involved in the game, thereby increasing the degree of fun of the game.

In addition, the creation information of the target virtual gain item is carried in the target frame synchronization instruction, and the target frame synchronization instruction is transmitted from the server to the client, thereby further avoiding, in the above embodiments, a cheating behavior caused by modifying local parameters of the user terminal in a conventional solution (such as a behavior of illegally acquiring the virtual gain item by decoding the interface), and improving the effects on preventing the cheating behavior.

In some embodiments, as detailed in FIG. 1d, between the steps 110 and 120, the present disclosure may further include the following step: determining that the live broadcasting room identifier information is located in a preset live broadcasting room white list (also referred to as a preset live broadcasting room whitelist).

The preset live broadcasting room white list is a preset white list for recording real and credible live broadcasting rooms. Specifically, after the step 110, a step of determining whether the live broadcasting room identifier information is located in the preset live broadcasting room white list may be first implemented. If the live broadcasting room identifier information is determined to be located in the preset live broadcasting room white list, the step 120 may then be implemented.

In the above embodiments, the step “determining that the live broadcasting room identifier information is located in the preset live broadcasting room white list” may be added between the steps 110 and 120, to avoid a behavior that some users virtually establish a live broadcasting room by improper means and virtually interact in the virtually established live broadcasting room, thereby avoiding a cheating behavior that a game character corresponding to the target game account gets a large number of virtual gain items, and further improving the fairness of the game.

In some embodiments, as detailed in FIG. 1d, the present disclosure may further include the following step: adding, when the game starts, all game accounts involved in the same game round to a temporary white list.

Accordingly, between the steps 120 and 150, an embodiment of the present disclosure may further include: determining that the target game account is located in a temporary white list.

The temporary white list is used to record game accounts corresponding to all players involved in the same game round. For example, assuming that the game is a 5v5 Multiplayer Online Battle Arena (MOBA for short), all players involved in the same game round may total ten (five friendly players and five enemy players); and accordingly, the temporary white list is used to record game accounts of the ten players. It should be understood that all of the players involved in the same game ground mentioned above may be less than ten players, and game characters of the part less than ten players are controlled by AI. In some embodiments, the game may also be a level-clearing battle royale game in which dozens of players are jointly involved; and accordingly, the temporary white list is used to record game accounts of the dozens of players mentioned above.

In the above embodiments, after the “determining the target game account corresponding to the live broadcasting room identifier information” and before the “transmitting the target frame synchronization instruction to the user terminal logged in with the target game account”, the target game account is determined to be located in the temporary white list, thereby determining that the target game account is playing the game, and avoiding wasting computing resources caused by issuing the target virtual gain item to a game account that is not in the game.

In some embodiments, before the step 150, the present disclosure may further include the following step: determining that game version numbers corresponding to all game accounts involved in the same game round are consistent.

In the above embodiments, by determining that the game version numbers corresponding to all of the game accounts involved in the same game round are consistent, local code files of all of the game accounts involved in the same game round can be determined to be consistent; thereby implementing same manifestation effects of an instruction for creating a prop and a skill transmitted from a given server on clients corresponding to all of the game accounts involved in the same game round, and enabling players involved in the game to compete fairly.

In some embodiments, the above step “determining that the game version numbers corresponding to all of the game accounts involved in the same game round are consistent” includes the following sub-steps S1 to S2.
S1: selecting a selected game version number with latest data from the game version numbers corresponding to all of the game accounts.

The selected game version number may be a game version number with the latest data among the game version numbers of all of the game accounts involved in the same game round. For example, assuming that the game accounts involved in the same game round total 32, of which 20 game accounts correspond to a game version number of version 1.0; 10 game accounts correspond to a game version number of version 1.2; 2 game accounts correspond to a game version number of version 1.6, and the version number of the latest game version released by the developer is version 2.0; the selected game version number may be version 1.6 (i.e., the game version number with the latest data among the game version numbers of all of the game accounts involved in the same game round).
S2: transmitting, for a game account corresponding to a game version number other than the selected game version number, an update data packet to the user terminal logged in with the game account, to update a game version number corresponding to the game account to the selected game version number.

After determining the selected game version number, the server can transmit the update data packet to a user terminal where a game account which is involved in the same game round and whose game version number is not the selected game version number is located, to update the game version number corresponding to the above game account to the selected game version number, so that the game version numbers of all of the players involved in the same game round are consistent.

Continuing with the above example, after selecting the selected game version number as version 1.6, the server can transmit an update data packet required to upgrade from the version 1.0 to the version 1.6 to a user terminal where the game version number 1.0 is located; and the server can also transmit an update data packet required to upgrade from the version 1.2 to the version 1.6 to a user terminal where the game version number 1.2 is located. Through the above operations, the game version numbers of the 32 game accounts involved in the same game round may all be the version 1.6, thereby achieving the purpose of consistent version numbers.

In the above embodiments, the game version number with the latest data is selected from the game accounts for use as a to-be-unified game version number, thereby exempting some players involved in the game from game update. Other players involved in the same game can play the game after updating to a game version number consistent with the selected game version number. The selected game version number may not be the latest game version released by the game developer, thereby reducing the number of to-be-upgraded-over versions for the other players, reducing the time for all of the players to wait for game updates, and saving the players' time.

In some embodiments, the above step “determining that the game version numbers corresponding to all of the game accounts involved in the same game round are consistent” may also specifically include: updating the game version numbers corresponding to all of the game accounts involved in the same game round to the latest game version released by the game developer. It should be understood that the specific mode of the “determining that the game version numbers corresponding to all of the game accounts involved in the same game round are consistent” should not be construed as limiting the present disclosure.

In some embodiments, the present disclosure may further include the following steps A1 to A3.
A1: acquiring, after any one game level of the game ends, a level result list transmitted from each game account among all game accounts involved in the game level.

The level result list may comprise pass or fail results of all of the game accounts involved in the game level. In some embodiments, in addition to the above results, the level result list may further include information such as accumulated points of all of the game accounts involved in the game level, use status of a prop or a skill, and level clearance time of players who have passed the level.

Continuing with the above example, assuming that all of the game accounts involved in the game level total 32, each of the 32 game accounts will transmit a level result list, totaling 32 level result lists. Each of the level result lists comprises information such as pass or fail results of the 32 game accounts on the game level recorded by the corresponding game accounts, accumulated points of the 32 game accounts, use status of a prop or a skill, and level clearance time of players who have passed the level.
A2: acquiring, in response to presence of a doubtful game account with an inconsistent level result in a plurality of the level result lists, a plurality of level results of the doubtful game account.

The doubtful game account is a game account with different level results in different level result lists. For example, assuming that game account xxx_17 is one of the 32 game accounts, if a level result list recorded by the game account itself shows that level result of the game account xxx_17 is pass; and level result lists recorded by other game accounts among the 32 game accounts show that level result of the game account xxx_17 is fail, the game account xxx 17 can be determined to be a doubtful game account.

The 32 game accounts are assessed successively in the above manner, thus obtaining doubtful game accounts among the 32 game accounts. For each of the doubtful game accounts, a plurality of corresponding level results of the doubtful game account can be obtained.
A3: determining a final level result of the doubtful game account based on the number of occurrences of each of the level results.

In some embodiments, for each of the doubtful game accounts, if the number of occurrences of a first level result of the doubtful game account is higher than the number of occurrences of a second level result, the first level result is used as the final level result. The plurality of level results comprise: the first level result and the second level result.

In the above embodiments, if a game account of a cheater falsifies its own level results through a cheating behavior, the level results of the game account of the cheater can still be corrected by comparing the level results of the game account of the cheater recorded by all of the game accounts involved in the game level to further ensure the fairness of the game.

In some embodiments, the present disclosure may further include the following steps B1 to B4.
B1: receiving a control instruction transmitted to a user terminal logged in with a first game account.

The first game account is any one game account among a plurality of game accounts involved in the same game round. In addition to receiving the control instruction transmitted from the server, the user terminal will further transmit a control instruction for the game character triggered by the user to the server.
B2: determining whether the control instruction only affects the first game account, executing step B3 if the control instruction only affects the first game account; and executing step B4 if the control instruction does not only affect the first game account.

The server is configured to determine: whether the control instruction is a control instruction that only affects the first game account. The control instruction that only affects the first game account includes related instructions for manipulating movement of the game character, such as instructions related to character jumping, sprinting, rolling, etc. If the control instruction does not only affect the first game account, for example, the control instruction is an instruction for manipulating movement of other game characters, step B4 is executed.
B3: determining an effectiveness result of the control instruction based on an extent of authority to which the control instruction belongs.

After the control instruction is determined to only affect the first game account, the effectiveness result of the control instruction can be further determined based on the extent of authority to which the control instruction belongs. In some embodiments, the step B3 specifically may include the following sub-steps B31 to B32.
B31: determining whether the control instruction is a control instruction beyond authority, executing step B4 if the control instruction is a control instruction beyond authority; and executing step B32 if the control instruction is not a control instruction beyond authority.

The control instruction beyond authority is a control instruction that is beyond transmission authority of the user terminal, for example, a target frame synchronization instruction carrying the creation information of the target virtual gain item. In some embodiments, a terminal control instruction list of control instructions allowed to be transmitted by the user terminal may be preset, and all control instructions beyond the terminal control instruction list may be considered as control instructions beyond authority.

If the user terminal issues a control instruction beyond authority, a game account logged in on the user terminal may be determined to have the possibility of cheating, and then step B4 is jumped to. If the control instruction is not a control instruction beyond authority, the control instruction is more likely to be a common control instruction for the user to manipulate the movement of the game character, and then step B32 is jumped to.
B32: determining that the control instruction is invalid.

The above steps B31 to B32 describe a specific embodiment of the step B3, and the step B3 may also be implemented through other sub-steps. The specific way to implement the step B3 should not be construed as limiting the present disclosure.
B4: determining that the control instruction is invalid.

As detailed in FIG. 1c, in the above embodiments, for the control instruction transmitted from the user terminal, whether the control instruction is invalid can be determined in two steps (i.e., pre-checking of the control instruction shown in FIG. 1c): first determining whether the control instruction only affects the first game account; further determining whether the control instruction is a control instruction beyond authority if the control instruction only affects the first game account; determining whether the control instruction is valid if the control instruction is not a control instruction beyond authority; and determining that the control instruction is invalid if the control instruction does not only affect the first game account or the control instruction is a control instruction beyond authority. In the above embodiments, the control instruction transmitted from the user terminal can be better managed to further avoid the occurrence of a cheating behavior.

Specifically, the above steps B1 to B4 can avoid two cheating behaviors as follows: modifying local memory data of the user terminal to simulate a behavior of acquiring a virtual gain item; and simulating the target frame synchronization instruction carrying the creation information of the target virtual gain item received by the user terminal and transmitted from the server to implement a behavior of acquiring the target virtual gain item.

In an embodiment of the present disclosure, an interaction notification message in a live broadcasting room may be received, a target game account corresponding to live broadcasting room identifier information in the interaction notification message in the live broadcasting room may be determined based on a first mapping relationship; and a target virtual gain item corresponding to interactive content identifier information in the interaction notification message in the live broadcasting room may be determined based on a second mapping relationship. Then, a target frame synchronization instruction carrying creation information of the target virtual gain item is generated. The target frame synchronization instruction is transmitted to a user terminal logged in with the target game account. Game progress can be synchronized between the target game account and other game accounts involved in a same game round, and the target game account is enabled to acquire the target virtual gain item in a game.

In an embodiment of the present disclosure, the creation information is carried in the target frame synchronization instruction transmitted from a server to the user terminal, to enable the target game account to acquire the target virtual gain item in the game. The creation information is transmitted from the server and cannot be separately generated locally on the user terminal, thereby avoiding a cheating behavior caused by modifying local parameters of the user terminal in an existing solution. Therefore, the embodiments of the present disclosure can improve the effects on preventing the cheating behavior, reduce the processing burden of the terminal device, and reduce power consumption of the terminal device.

The method described in the above embodiments will be further detailed below.

In this embodiment, the method of the embodiments of the present disclosure will be detailed when the virtual item gain is a game prop or skill as an example.

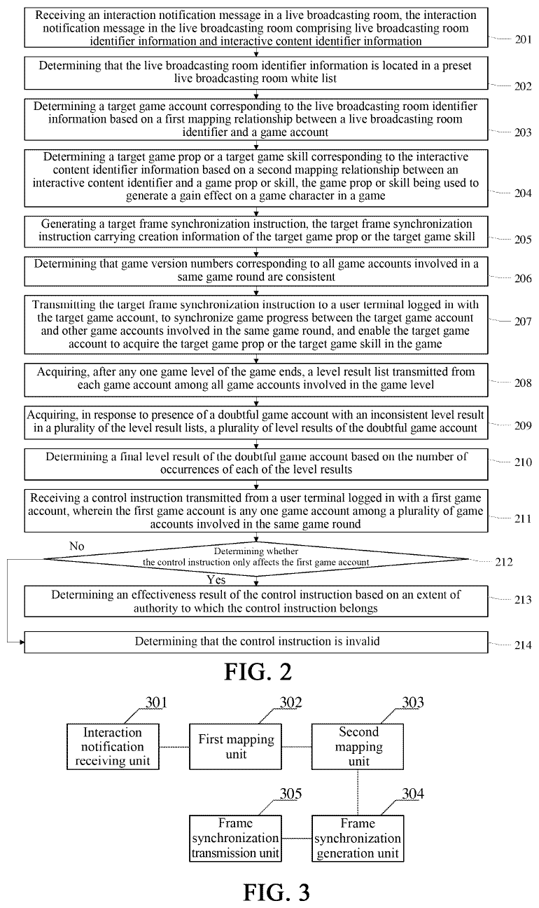

Referring to FIG. 2, FIG. 2 is a schematic diagram of a specific embodiment of a method for transmitting a virtual gain item provided in an embodiment of the present disclosure. A specific process of a method for transmitting a game prop or skill is as follows.
201: receiving an interaction notification message in a live broadcasting room, the interaction notification message in the live broadcasting room comprising live broadcasting room identifier information and interactive content identifier information.
202: determining that the live broadcasting room identifier information is located in a preset live broadcasting room white list.
203: determining a target game account corresponding to the live broadcasting room identifier information based on a first mapping relationship between a live broadcasting room identifier and a game account.
204: determining a target game prop or a target game skill corresponding to the interactive content identifier information based on a second mapping relationship between an interactive content identifier and a game prop or skill, the game prop or skill being used to generate a gain effect on a game character in a game.
205: generating a target frame synchronization instruction, the target frame synchronization instruction carrying creation information of the target game prop or the target game skill.
206: determining that game version numbers corresponding to all game accounts involved in a same game round are consistent.

In some embodiments, the step 206 may specifically include the following sub-steps: selecting a selected game version number with latest data from the game version numbers corresponding to all of the game accounts; and transmitting, for a game account corresponding to a game version number other than the selected game version number, an update data packet to a user terminal logged in with the game account, to update a game version number corresponding to the game account to the selected game version number.
207: transmitting the target frame synchronization instruction to a user terminal logged in with the target game account, to synchronize game progress between the target game account and other game accounts involved in the same game round, and enable the target game account to acquire the target game prop or the target game skill in the game.
208: acquiring, after any one game level of the game ends, a level result list transmitted from each game account among all game accounts involved in the game level.
209: acquiring, in response to presence of a doubtful game account with an inconsistent level result in a plurality of the level result lists, a plurality of level results of the doubtful game account.
210: determining a final level result of the doubtful game account based on the number of occurrences of each of the level results.
211: receiving a control instruction transmitted from a user terminal logged in with a first game account, where the first game account is any one game account among a plurality of game accounts involved in the same game round.
212: determining whether the control instruction only affects the first game account, executing step 213 if the control instruction only affects the first game account; and executing step 214 if the control instruction does not only affect the first game account.
213: determining an effectiveness result of the control instruction based on an extent of authority to which the control instruction belongs.

In some embodiments, the step 213 may specifically include the following sub-steps: determining whether the control instruction is a control instruction beyond authority; determining that the control instruction is invalid if the control instruction is a control instruction beyond authority; and determining that the control instruction is valid if the control instruction is not a control instruction beyond authority.
214: determining that the control instruction is invalid.

In an embodiment of the present disclosure, an interaction notification message in a live broadcasting room may be received, a target game account corresponding to live broadcasting room identifier information in the interaction notification message in the live broadcasting room may be determined based on a first mapping relationship; and a target game prop or a target game skill corresponding to interactive content identifier information in the interaction notification message in the live broadcasting room may be determined based on a second mapping relationship. Then, a target frame synchronization instruction carrying creation information of the target game prop or the target game skill is generated. The target frame synchronization instruction is transmitted to a user terminal logged in with the target game account. Game progress can be synchronized between the target game account and other game accounts involved in a same game round, and the target game account is enabled to acquire the target game prop or the target game skill in a game. In an embodiment of the present disclosure, the creation information is carried in the target frame synchronization instruction transmitted from a server to the user terminal, to enable the target game account to acquire the target game prop or the target game skill in the game. The creation information is transmitted from the server and cannot be separately generated locally on the user terminal, thereby avoiding a cheating behavior caused by modifying local parameters of the user terminal in an existing solution.

As can be seen from the above, the embodiments of the present disclosure can improve the effects on preventing the cheating behavior, reduce the processing burden of the terminal device, and reduce power consumption of the terminal device.

In order to better implement the above methods, an embodiment of the present disclosure further provides an apparatus for transmitting a virtual gain item. The apparatus for transmitting a virtual gain item may be specifically integrated in an electronic device, which may be a device, such as a terminal or a server. The terminal may be a device, such as a mobile phone, a tablet computer, a smart Bluetooth device, a notebook computer, or a personal computer; and the server may be a single server, or may be a server cluster composed of a plurality of servers.

For example, in this embodiment, the method of the embodiments of the present disclosure will be detailed when the apparatus for transmitting a virtual item gain is specifically integrated in a server as an example.

Referring to FIG. 3, FIG. 3 is a structural block diagram of an apparatus for transmitting a virtual gain item provided in an embodiment of the present disclosure. The apparatus for transmitting a virtual gain item may comprise: an interaction notification receiving unit 301 configured to receive an interaction notification message in a live broadcasting room, where the interaction notification message in the live broadcasting room comprises live broadcasting room identifier information and interactive content identifier information; a first mapping unit 302 configured to determine a target game account corresponding to the live broadcasting room identifier information based on a first mapping relationship between a live broadcasting room identifier and a game account; a second mapping unit 303 configured to determine a target virtual gain item corresponding to the interactive content identifier information based on a second mapping relationship between an interactive content identifier and the virtual gain item, where the virtual gain item is a virtual item for generating a gain effect on a game character in a game; a frame synchronization generation unit 304 configured to generate a target frame synchronization instruction, where the target frame synchronization instruction carries creation information of the target virtual gain item; and a frame synchronization transmission unit 305 configured to transmit the target frame synchronization instruction to a user terminal logged in with the target game account, to synchronize game progress between the target game account and other game accounts involved in a same game round, and enable the target game account to acquire the target virtual gain item in the game.

In some embodiments, the apparatus further comprises: a game version determination unit configured to determine that game version numbers corresponding to all game accounts involved in the same game round are consistent.

In some embodiments, the game version determination unit is configured to: a version selection subunit configured to select a selected game version number with latest data from the game version numbers corresponding to all of the game accounts; and an update data packet subunit configured to transmit, for a game account corresponding to a game version number other than the selected game version number, an update data packet to the user terminal logged in with the game account, to update a game version number corresponding to the game account to the selected game version number.

In some embodiments, the apparatus further comprises: a result list unit configured to acquire, after any one game level of the game ends, a level result list transmitted from each game account among all game accounts involved in the game level; a result acquisition unit configured to acquire, in response to presence of a doubtful game account with an inconsistent level result in a plurality of the level result lists, a plurality of level results of the doubtful game account; and a final result unit configured to determine a final level result of the doubtful game account based on the number of occurrences of each of the level results.

In some embodiments, the apparatus further comprises: a control instruction receiving unit configured to receive a control instruction transmitted from a user terminal logged in with a first game account, where the first game account is any one game account among a plurality of game accounts involved in the same game round; an effect determination unit configured to determine whether the control instruction only affects the first game account; an effectiveness result unit configured to determine, in response to the control instruction only affecting the first game account, an effectiveness result of the control instruction based on an extent of authority to which the control instruction belongs; and an instruction invalidation unit configured to determine, in response to the control instruction not only affecting the first game account, that the control instruction is invalid.

In some embodiments, the effectiveness result unit comprises: an instruction determination subunit configured to determine whether the control instruction is a control instruction beyond authority; an invalid instruction subunit configured to determine, in response to the control instruction being a control instruction beyond authority, that the control instruction is invalid; and an instruction validation subunit configured to determine, in response to the control instruction not being a control instruction beyond authority, that the control instruction is valid.

In some embodiments, the apparatus further comprises: a live broadcasting room white list determination unit configured to determine that the live broadcasting room identifier information is located in a preset live broadcasting room white list.

In some embodiments, the apparatus further comprises: a temporary white list unit configured to add, when the game starts, all game accounts involved in the same game round to a temporary white list; and a temporary white list determination unit configured to determine that the target game account is located in a temporary white list.

In a specific implementation, the above units may be implemented as independent entities, or may be combined in any way and implemented as a same entity or several entities. The above method embodiments may be referred to for specific implementations of the above units, which will not be repeated here.

In an embodiment of the present disclosure, an interaction notification message in a live broadcasting room may be received, a target game account corresponding to live broadcasting room identifier information in the interaction notification message in the live broadcasting room may be determined based on a first mapping relationship; and a target virtual gain item corresponding to interactive content identifier information in the interaction notification message in the live broadcasting room may be determined based on a second mapping relationship. Then, a target frame synchronization instruction carrying creation information of the target virtual gain item is generated. The target frame synchronization instruction is transmitted to a user terminal logged in with the target game account. Game progress can be synchronized between the target game account and other game accounts involved in a same game round, and the target game account is enabled to acquire the target virtual gain item in a game. In an embodiment of the present disclosure, the creation information is carried in the target frame synchronization instruction transmitted from a server to the user terminal, to enable the target game account to acquire the target virtual gain item in the game. The creation information is transmitted from the server and cannot be separately generated locally on the user terminal, thereby avoiding a cheating behavior caused by modifying local parameters of the user terminal in an existing solution. As can be seen from the above, the embodiments of the present disclosure can improve the effects on preventing the cheating behavior, reduce the processing burden of the terminal device, and reduce power consumption of the terminal device.

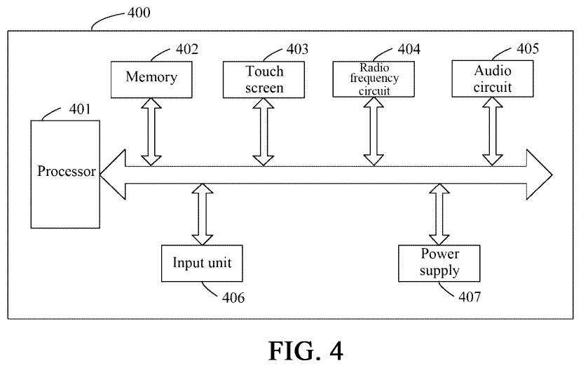

Accordingly, an embodiment of the present disclosure further provides a computer device, which may be a terminal. As shown in FIG. 4, FIG. 4 is a schematic structural diagram of a computer device provided in an embodiment of the present disclosure. The computer device 400 comprises a processor 401 having one or more than one processing core, a memory 402 having one or more than one computer-readable storage medium, and a computer program stored on the memory 402 and runnable on the processor. The processor 401 is electrically connected to the memory 402. Those skilled in the art can understand that the structure of the computer device shown in the figure does not constitute any limitation to the computer device, and may comprise more or fewer components than those shown in the figure, or may combine some components, or may have different component arrangements.

The processor 401 is a control center of the computer device 400, connects various parts of the entire computer device 400 using various interfaces and wires, implements various functions of the computer device 400 by running or loading software programs and/or modules stored in the memory 402, and implements data processing by invoking data stored in the memory 402, thereby performing overall monitoring on the computer device 400.

In an embodiment of the present disclosure, the processor 401 in the computer device 400 will load instructions corresponding to processes of one or more than one application program into the memory 402 following the steps below, and the processor 401 runs the application program stored in the memory 402, thereby implementing various functions: receiving an interaction notification message in a live broadcasting room, where the interaction notification message in the live broadcasting room comprises live broadcasting room identifier information and interactive content identifier information; determining a target game account corresponding to the live broadcasting room identifier information based on a first mapping relationship between a live broadcasting room identifier and a game account; determining a target virtual gain item corresponding to the interactive content identifier information based on a second mapping relationship between an interactive content identifier and a virtual gain item, where the virtual gain item is a virtual item for generating a gain effect on a game character in a game; generating a target frame synchronization instruction, where the target frame synchronization instruction carries creation information of the target virtual gain item; and transmitting the target frame synchronization instruction to a user terminal logged in with the target game account, to synchronize game progress between the target game account and other game accounts involved in a same game round, and enable the target game account to acquire the target virtual gain item in the game.

In some embodiments, before the transmitting the target frame synchronization instruction to the user terminal logged in with the target game account, the method further comprises: determining that game version numbers corresponding to all game accounts involved in the same game round are consistent.

In some embodiments, the determining that the game version numbers corresponding to all of the game accounts involved in the same game round are consistent comprises: selecting a selected game version number with latest data from the game version numbers corresponding to all of the game accounts; and transmitting, for a game account corresponding to a game version number other than the selected game version number, an update data packet to the user terminal logged in with the game account, to update a game version number corresponding to the game account to the selected game version number.

In some embodiments, the method further comprises: acquiring, after any one game level of the game ends, a level result list transmitted from each game account among all game accounts involved in the game level; acquiring, in response to presence of a doubtful game account with an inconsistent level result in a plurality of the level result lists, a plurality of level results of the doubtful game account; and determining a final level result of the doubtful game account based on the number of occurrences of each of the level results.

In some embodiments, the method further comprises: receiving a control instruction transmitted from a user terminal logged in with a first game account, where the first game account is any one game account among a plurality of game accounts involved in the same game round; determining whether the control instruction only affects the first game account; determining, in response to the control instruction only affecting the first game account, an effectiveness result of the control instruction based on an extent of authority to which the control instruction belongs; and determining, in response to the control instruction not only affecting the first game account, that the control instruction is invalid.

In some embodiments, the determining the effectiveness result of the control instruction based on the extent of authority to which the control instruction belongs comprises: determining whether the control instruction is a control instruction beyond authority; determining, in response to the control instruction being a control instruction beyond authority, that the control instruction is invalid; and determining, in response to the control instruction not being a control instruction beyond authority, that the control instruction is valid.

In some embodiments, after the receiving the interaction notification message in the live broadcasting room, and before the determining the target game account corresponding to the live broadcasting room identifier information based on the first mapping relationship between the live broadcasting room identifier and the game account, the method further comprises: determining that the live broadcasting room identifier information is located in a preset live broadcasting room white list.

In some embodiments, the method further comprises: adding, when the game starts, all game accounts involved in the same game round to a temporary white list. Accordingly, after the determining the target game account corresponding to the live broadcasting room identifier information based on the first mapping relationship between the live broadcasting room identifier and the game account, and before the transmitting the target frame synchronization instruction to the user terminal logged in with the target game account, the method further comprises: determining that the target game account is located in a temporary white list.

The above embodiments may be referred to for specific implementations of the above operations, which will not be repeated here.

In some embodiments, as shown in FIG. 4, the computer device 400 further comprises: a touch screen 403, a radio frequency circuit 404, an audio circuit 405, an input unit 406, and a power supply 407. The processor 401 is electrically connected to the touch screen 403, the radio frequency circuit 404, the audio circuit 405, the input unit 406, and the power supply 407 respectively. Those skilled in the art can understand that the structure of the computer device shown in FIG. 4 does not constitute any limitation to the computer device, and may comprise more or fewer components than those shown in the figure, or may combine some components, or may have different component arrangements.

The touch screen 403 may be configured to display a graphical user interface and receive an operating instruction generated by a user acting on the graphical user interface. The touch screen 403 may include a display panel and a touch panel. The display panel may be configured to display information inputted by the user or information provided to the user, and various graphical user interfaces of the computer device. These graphical user interfaces may be composed of graphics, texts, icons, videos, and any combination thereof. In some embodiments, the display panel may be configured in the form of, e.g., a Liquid Crystal Display (LCD) or an Organic Light-Emitting Diode (OLED). The touch panel may be configured to collect a touch operation of the user thereon or in the vicinity thereof (such as an operation of the user on or in the vicinity of the touch panel using a finger, a touchpen, or any appropriate object or accessory), and generate a corresponding operating instruction, and the operating instruction executes a corresponding program. In some embodiments, the touch panel may include two parts: a touch detection apparatus and a touch controller. The touch detection apparatus detects a touch orientation of the user, detects a signal brought by the touch operation, and transmits the signal to the touch controller. The touch controller receives touch information from the touch detection apparatus, converts it into contact point coordinates, then transmits the contact point coordinates to the processor 401, can receive a command transmitted from the processor 401, and can execute the command. The touch panel can cover the display panel. After detecting the touch operation on or in the vicinity of the touch panel, the touch panel transmits the touch operation to the processor 401 to determine a type of a touch event, and then the processor 401 provides a corresponding visual output on the display panel based on the type of the touch event. In an embodiment of the present disclosure, the touch panel and the display panel may be integrated into the touch screen 403 to implement input and output functions. However, in some embodiments, the touch panel and the touch panel may be used as two standalone components to implement input and output functions. In this configuration, the touch screen 403 may also be used as a part of the input unit 406 to implement the input function.

The radio frequency circuit 404 may be configured to transmit/receive a radio frequency signal, so as to establish wireless communication with a network device or other computer devices through wireless communication, and transmit/receive signals to/from the network device or other computer devices.

The audio circuit 405 may be configured to provide an audio interface between the user and the computer device through a speaker or a microphone. The audio circuit 405 can transmit an electrical signal converted from received audio data to the speaker, which converts the electrical signal into an acoustical signal and outputs the acoustical signal. On the other hand, the microphone converts the collected acoustical signal into an electrical signal, which is received by the audio circuit 405, and then converted into audio data. Then, the audio data is outputted to the processor 401 for processing, and then transmitted to, for example, another computer device through the radio frequency circuit 404, or the audio data is outputted to the memory 402 for further processing. The audio circuitry 405 may further include an earphone jack, to provide communication between a peripheral earphone and the computer device.

The input unit 406 may be configured to receive an inputted number, character information, or user feature information (such as a fingerprint, an iris, or facial information), and generate keyboard, mouse, joystick, optical or trackball signal input related to user settings and function control.

The power supply 407 is configured to power various components of the computer device 400. In some embodiments, the power supply 407 may be logically connected to the processor 401 through a power management system, thereby managing functions such as charging, discharging, and power consumption management through the power management system. The power supply 407 may further comprise one or more than one DC or AC power supply, a recharging system, a power failure detection circuit, a power converter or inverter, a power status indicator, and any other components.

Although not shown in FIG. 4, the computer device 400 may further comprise, e.g., a camera, a sensor, a wireless fidelity module, and a Bluetooth module, which will not be repeated here.

The computer device provided in an embodiment of the present disclosure can receive an interaction notification message in a live broadcasting room, determine a target game account corresponding to live broadcasting room identifier information in the interaction notification message in the live broadcasting room based on a first mapping relationship; and determine a target virtual gain item corresponding to interactive content identifier information in the interaction notification message in the live broadcasting room based on a second mapping relationship. Then, a target frame synchronization instruction carrying creation information of the target virtual gain item is generated. The target frame synchronization instruction is transmitted to a user terminal logged in with the target game account. Game progress can be synchronized between the target game account and other game accounts involved in a same game round, and the target game account is enabled to acquire the target virtual gain item in a game. In an embodiment of the present disclosure, the creation information is carried in the target frame synchronization instruction transmitted from a server to the user terminal, to enable the target game account to acquire the target virtual gain item in the game. The creation information is transmitted from the server and cannot be separately generated locally on the user terminal, thereby avoiding a cheating behavior caused by modifying local parameters of the user terminal in an existing solution.

In the above embodiments, particular emphasis is laid on description of each embodiment. Relevant descriptions of other embodiments may be referred to for parts that are not described in detail in an embodiment.

Those of ordinary skills in the art can understand that all or a part of the steps in the methods of the above embodiments can be completed through instructions, or be completed by controlling related hardware through instructions, where the instructions may be stored in a computer-readable storage medium, and loaded and executed by a processor.

To this end, an embodiment of the present disclosure provides a computer-readable storage medium, storing a plurality of computer programs, where the computer programs can be loaded by a processor to implement steps of any one method for tagging a virtual item provided in the embodiments of the present disclosure. For example, the computer programs can implement the following steps: receiving an interaction notification message in a live broadcasting room, where the interaction notification message in the live broadcasting room comprises live broadcasting room identifier information and interactive content identifier information; determining a target game account corresponding to the live broadcasting room identifier information based on a first mapping relationship between a live broadcasting room identifier and a game account; determining a target virtual gain item corresponding to the interactive content identifier information based on a second mapping relationship between an interactive content identifier and a virtual gain item, where the virtual gain item is a virtual item for generating a gain effect on a game character in a game; generating a target frame synchronization instruction, where the target frame synchronization instruction carries creation information of the target virtual gain item; and transmitting the target frame synchronization instruction to a user terminal logged in with the target game account, to synchronize game progress between the target game account and other game accounts involved in a same game round, and enable the target game account to acquire the target virtual gain item in the game.

In some embodiments, before the transmitting the target frame synchronization instruction to the user terminal logged in with the target game account, the method further comprises: determining that game version numbers corresponding to all game accounts involved in the same game round are consistent.

In some embodiments, the determining that the game version numbers corresponding to all of the game accounts involved in the same game round are consistent comprises: selecting a selected game version number with latest data from the game version numbers corresponding to all of the game accounts; and transmitting, for a game account corresponding to a game version number other than the selected game version number, an update data packet to the user terminal logged in with the game account, to update a game version number corresponding to the game account to the selected game version number.

In some embodiments, the method further comprises: acquiring, after any one game level of the game ends, a level result list transmitted from each game account among all game accounts involved in the game level; acquiring, in response to presence of a doubtful game account with an inconsistent level result in a plurality of the level result lists, a plurality of level results of the doubtful game account; and determining a final level result of the doubtful game account based on the number of occurrences of each of the level results.

In some embodiments, the method further comprises: receiving a control instruction transmitted from a user terminal logged in with a first game account, where the first game account is any one game account among a plurality of game accounts involved in the same game round; determining whether the control instruction only affects the first game account; determining, in response to the control instruction only affecting the first game account, an effectiveness result of the control instruction based on an extent of authority to which the control instruction belongs; and determining, in response to the control instruction not only affecting the first game account, that the control instruction is invalid.

In some embodiments, the determining the effectiveness result of the control instruction based on the extent of authority to which the control instruction belongs comprises: determining whether the control instruction is a control instruction beyond authority; determining, in response to the control instruction being a control instruction beyond authority, that the control instruction is invalid; and determining, in response to the control instruction not being a control instruction beyond authority, that the control instruction is valid.

In some embodiments, after the receiving the interaction notification message in the live broadcasting room, and before the determining the target game account corresponding to the live broadcasting room identifier information based on the first mapping relationship between the live broadcasting room identifier and the game account, the method further comprises: determining that the live broadcasting room identifier information is located in a preset live broadcasting room whitelist.

In some embodiments, the method further comprises: adding, when the game starts, all game accounts involved in the same game round to a temporary whitelist. Accordingly, after the determining the target game account corresponding to the live broadcasting room identifier information based on the first mapping relationship between the live broadcasting room identifier and the game account, and before the transmitting the target frame synchronization instruction to the user terminal logged in with the target game account, the method further comprises: determining that the target game account is located in a temporary white list (also referred to as a temporary whitelist).

A computer program stored in a computer-readable storage medium provided in an embodiment of the present disclosure can receive an interaction notification message in a live broadcasting room, determine a target game account corresponding to live broadcasting room identifier information in the interaction notification message in the live broadcasting room based on a first mapping relationship; and determine a target virtual gain item corresponding to interactive content identifier information in the interaction notification message in the live broadcasting room based on a second mapping relationship. Then, a target frame synchronization instruction carrying creation information of the target virtual gain item is generated. The target frame synchronization instruction is transmitted to a user terminal logged in with the target game account. Game progress can be synchronized between the target game account and other game accounts involved in a same game round, and the target game account is enabled to acquire the target virtual gain item in a game. In an embodiment of the present disclosure, the creation information is carried in the target frame synchronization instruction transmitted from a server to the user terminal, to enable the target game account to acquire the target virtual gain item in the game. The creation information is transmitted from the server and cannot be separately generated locally on the user terminal, thereby avoiding a cheating behavior caused by modifying local parameters of the user terminal in an existing solution.

The above embodiments may be referred to for specific implementations of the above operations, which will not be repeated here.

The storage medium may comprise, e.g., a Read Only Memory (ROM), a Random Access Memory (RAM), a magnetic disk, or an optical disk.

A method for transmitting a virtual gain item, an apparatus for transmitting a virtual gain item, a mobile terminal, and a storage medium provided in the embodiments of the present disclosure are introduced in detail above. Specific examples are used herein to illustrate the principles and implementations of the present disclosure. The description of the above embodiments is only provided to help in understanding the method of the present disclosure and core concept thereof. Moreover, those skilled in the art will make alterations to the specific embodiments and application scope based on the concept of the present disclosure. To sum up, the content of the present specification should not be construed as limiting the present disclosure.

1. A method for transmitting a virtual gain item, comprising:
receiving an interaction notification message in a live broadcasting room, wherein the interaction notification message in the live broadcasting room comprises a live broadcasting room identifier and an interactive content identifier;
determining a target game account corresponding to the live broadcasting room identifier based on a first mapping relationship;
determining a target virtual gain item corresponding to the interactive content identifier based on a second mapping relationship, wherein the target virtual gain item generates a gain effect on a game character in a game;
generating a target frame synchronization instruction, wherein the target frame synchronization instruction comprises creation information of the target virtual gain item; and
transmitting the target frame synchronization instruction to a user terminal logged in with the target game account, to synchronize game progress between the target game account and other game accounts involved in a same game round, and to enable the target game account to acquire the target virtual gain item in the game.

2. The method for transmitting a virtual gain item according to claim 1, wherein, before transmitting the target frame synchronization instruction to the user terminal logged in with the target game account, the method further comprises:
determining that game version numbers of all game accounts involved in the same game round are consistent.

3. The method for transmitting a virtual gain item according to claim 2, wherein determining that the game version numbers of all of the game accounts involved in the same game round are consistent comprises:
selecting a target game version number with latest data from the game version numbers of all game accounts; and
transmitting, for a game account having a game version number other than the target game version number, an update data packet to the user terminal logged in with the game account, to update a game version number of the game account to the target game version number.

4. The method for transmitting a virtual gain item according to claim 1, further comprising:
after completion of a game level, acquiring a level result list transmitted from each game account among all game accounts involved in the game level;
in response to presence of a doubtful game account with an inconsistent level result in a plurality of the level result lists, acquiring a plurality of level results of the doubtful game account; and
determining a final level result of the doubtful game account based on a number of occurrences of each of the level results.

5. The method for transmitting a virtual gain item according to claim 1, further comprising:
receiving a control instruction transmitted from a user terminal logged in with a first game account, wherein the first game account is one of a plurality of game accounts involved in the same game round;
determining whether the control instruction affects only the first game account;
in response to determining that the control instruction affects only the first game account, determining an effectiveness result of the control instruction based on an extent of authority associated with the control instruction; and
in response to determining that the control instruction affects more than the first game account, determining that the control instruction is invalid.

6. The method for transmitting a virtual gain item according to claim 5, wherein determining the effectiveness result of the control instruction based on the extent of authority associated with the control instruction comprises:
determining whether the control instruction exceeds an authority limit;
in response to determining that the control instruction exceeds the authority limit, determining that the control instruction is invalid; and
in response to determining that the control instruction does not exceed the authority limit, determining that the control instruction is valid.

7. The method for transmitting a virtual gain item according to claim 1, wherein, after receiving the interaction notification message in the live broadcasting room, and before the determining the target game account corresponding to the live broadcasting room identifier based on the first mapping relationship, the method further comprises:
determining that the live broadcasting room identifier is included in a preset live broadcasting room whitelist.

8. The method for transmitting a virtual gain item according to claim 1, further comprising:
adding, when the game starts, all game accounts involved in the same game round to a temporary whitelist; and
after determining the target game account corresponding to the live broadcasting room identifier based on the first mapping relationship, and before transmitting the target frame synchronization instruction to the user terminal logged in with the target game account, determining that the target game account is included in a temporary whitelist.

9. (canceled)

10. A system, comprising:
one or more memories collectively containing one or more programs; and
one or more processors, wherein the one or more processors are configured to, individually or collectively, perform an operation comprising:
receiving an interaction notification message in a live broadcasting room, wherein the interaction notification message in the live broadcasting room comprises a live broadcasting room identifier and an interactive content identifier;
determining a target game account corresponding to the live broadcasting room identifier based on a first mapping relationship;
determining a target virtual gain item corresponding to the interactive content identifier based on a second mapping relationship, wherein the target virtual gain item generates a gain effect on a game character in a game;
generating a target frame synchronization instruction, wherein the target frame synchronization instruction comprises creation information of the target virtual gain item; and
transmitting the target frame synchronization instruction to a user terminal logged in with the target game account, to synchronize game progress between the target game account and other game accounts involved in a same game round, and to enable the target game account to acquire the target virtual gain item in the game.

11. One or more non-transitory computer-readable storage media containing, in any combination, computer program code that, when executable by a computer system, perform an operation comprising:
receiving an interaction notification message in a live broadcasting room, wherein the interaction notification message in the live broadcasting room comprises a live broadcasting room identifier and an interactive content identifier;
determining a target game account corresponding to the live broadcasting room identifier based on a first mapping relationship;
determining a target virtual gain item corresponding to the interactive content identifier based on a second mapping relationship, wherein the target virtual gain item generates a gain effect on a game character in a game;
generating a target frame synchronization instruction, wherein the target frame synchronization instruction comprises creation information of the target virtual gain item; and
transmitting the target frame synchronization instruction to a user terminal logged in with the target game account, to synchronize game progress between the target game account and other game accounts involved in a same game round, and to enable the target game account to acquire the target virtual gain item in the game.

12. The system according to claim 10, wherein, before transmitting the target frame synchronization instruction to the user terminal logged in with the target game account, the operation further comprises:
determining that game version numbers of all game accounts involved in the same game round are consistent.

13. The system according to claim 12, wherein determining that the game version numbers of all of the game accounts involved in the same game round are consistent comprises:
selecting a target game version number with latest data from the game version numbers of all game accounts; and
transmitting, for a game account having a game version number other than the target game version number, an update data packet to the user terminal logged in with the game account, to update a game version number of the game account to the target game version number.

14. The system according to claim 10, wherein the operation further comprises:
after completion of a game level, acquiring a level result list transmitted from each game account among all game accounts involved in the game level;
in response to presence of a doubtful game account with an inconsistent level result in a plurality of the level result lists, acquiring a plurality of level results of the doubtful game account; and
determining a final level result of the doubtful game account based on a number of occurrences of each of the level results.

15. The system according to claim 10, wherein the operation further comprises:
receiving a control instruction transmitted from a user terminal logged in with a first game account, wherein the first game account is one of a plurality of game accounts involved in the same game round;
determining whether the control instruction affects only the first game account;
in response to determining that the control instruction affects only the first game account, determining an effectiveness result of the control instruction based on an extent of authority associated with the control instruction; and
in response to determining that the control instruction affects more than the first game account, determining that the control instruction is invalid.

16. The system according to claim 15, wherein determining the effectiveness result of the control instruction based on the extent of authority associated with the control instruction comprises:
determining whether the control instruction exceeds an authority limit;
in response to determining that the control instruction exceeds the authority limit, determining that the control instruction is invalid; and
in response to determining that the control instruction does not exceed the authority limit, determining that the control instruction is valid.

17. The system according to claim 10, wherein, after receiving the interaction notification message in the live broadcasting room, and before the determining the target game account corresponding to the live broadcasting room identifier based on the first mapping relationship, the operation further comprises:
determining that the live broadcasting room identifier is included in a preset live broadcasting room whitelist.

18. The system according to claim 10, wherein the operation further comprises:
adding, when the game starts, all game accounts involved in the same game round to a temporary whitelist; and
after determining the target game account corresponding to the live broadcasting room identifier based on the first mapping relationship, and before transmitting the target frame synchronization instruction to the user terminal logged in with the target game account, determining that the target game account is included in a temporary whitelist.

19. The one or more non-transitory computer-readable storage media according to claim 11, wherein, before transmitting the target frame synchronization instruction to the user terminal logged in with the target game account, the operation further comprises:
determining that game version numbers of all game accounts involved in the same game round are consistent.

20. The one or more non-transitory computer-readable storage media according to claim 11, wherein the operation further comprises:
after completion of a game level, acquiring a level result list transmitted from each game account among all game accounts involved in the game level;
in response to presence of a doubtful game account with an inconsistent level result in a plurality of the level result lists, acquiring a plurality of level results of the doubtful game account; and
determining a final level result of the doubtful game account based on a number of occurrences of each of the level results.

21. The one or more non-transitory computer-readable storage media according to claim 11, wherein the operation further comprises:
receiving a control instruction transmitted from a user terminal logged in with a first game account, wherein the first game account is one of a plurality of game accounts involved in the same game round;
determining whether the control instruction affects only the first game account;
in response to determining that the control instruction affects only the first game account, determining an effectiveness result of the control instruction based on an extent of authority associated with the control instruction; and
in response to determining that the control instruction affects more than the first game account, determining that the control instruction is invalid.
